(19) United States
(12) Patent Application Publication
(10) Pub. No.: US 2011/0168891 A1
(43) Pub. Date: Jul. 14, 2011

(54) SYSTEMS, METHODS AND DEVICES FOR IMPROVED IMAGING AND SENSATION OF OBJECTS

(75) Inventors: Daniel van der Weide, Verona, WI (US); John Grade, Waunakee, WI (US)

(73) Assignee: TERA-X, LLC, Middleton, WI (US)

(21) Appl. No.: 12/116,659

(22) Filed: May 7, 2008

Related U.S. Application Data
(60) Provisional application No. 60/927,966, filed on May 7, 2007.

(51) Int. Cl. G02B 26/10; G01J 5/00

(52) U.S. Cl. 250/334; 250/338.1; 250/334

(57) ABSTRACT

The present invention provides devices, systems and methods for imaging and sensation of objects. In particular, the present invention provides devices, systems and methods for spectroscopic imaging and sensation of objects.

### CROSS-REFERENCE TO RELATED APPLICATION

The present invention claims priority to pending U.S. Provisional Application No. 60/927,966, filed May 7, 2007, entitled “Systems, Methods and Devices for Improved Imaging and Sensation of Objects,” which is herein incorporated by reference in its entirety.

### FIELD OF THE INVENTION

The present invention provides devices, systems and methods for imaging and sensation of objects. In particular, the present invention provides devices, systems and methods for spectroscopic imaging and sensation of objects.

### BACKGROUND

Improved systems, methods and devices for imaging and sensation are needed.

### SUMMARY

The present invention provides devices, systems and methods for imaging and sensation of objects. In particular, the present invention provides devices, systems and methods for spectroscopic imaging and sensation of objects.

### BRIEF DESCRIPTION OF THE DRAWINGS

FIG. 1 shows an embodiment of the present invention.

FIG. 2 shows an embodiment of the present invention.

FIG. 3 shows an embodiment of the present invention.

FIG. 4 shows an embodiment of the present invention.

FIG. 5 shows an embodiment of the present invention.

FIG. 6 shows an embodiment of the present invention.

FIG. 7 shows an embodiment of the present invention.

FIG. 8 shows an embodiment of the present invention.

FIG. 9 shows an embodiment of the present invention.

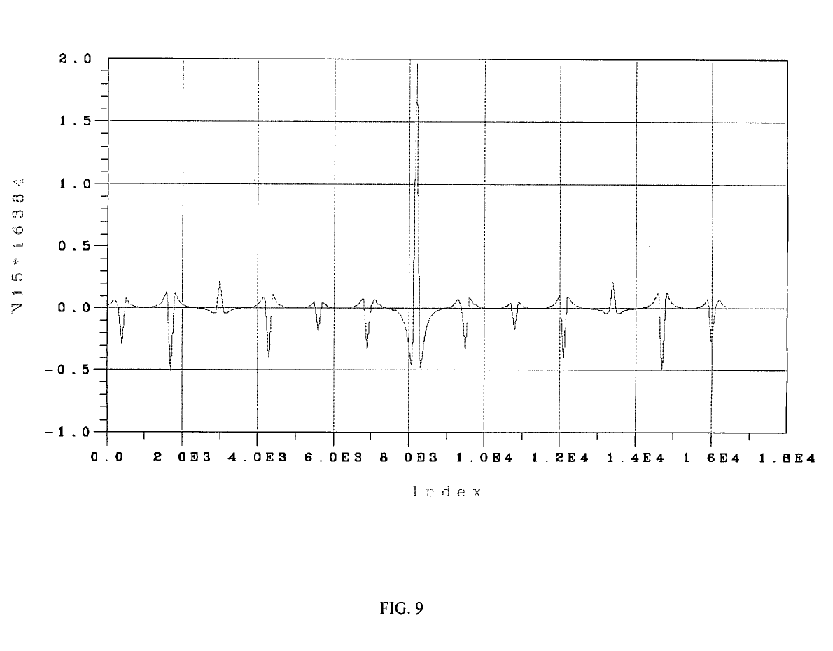

### DETAILED DESCRIPTION

Providing defense against asymmetric threats under all environmental conditions requires both broad spectrum sensing and highly mobile platforms. Embodiments of the present invention provide broad spectral sensing with co-located visible, infrared (IR) and terahertz (THz) sensors that are small, light and powerful enough to provide ˜100 m or greater standoff detection, yet be able to be mounted on an unmanned aerial vehicle (UAV) or used in a handheld format or other convenient formats. By enabling ultralight low-power sensors that fuse images from a plurality of spectral regimes, the systems, methods, and device of the present invention offer a new broadly applicable approach to counteracting asymmetric threats.

In some embodiments, the systems, methods, and device of the present invention provide each of visible, infrared and terahertz sensors. Since visible and IR sensors are already well-established, the keys to providing ultralight low-power sensors that fuse images from these three spectral regimes lie primarily in provision of effective means for generating, propagating, detecting and processing broadband THz waveforms. To this end, embodiments of the present invention provide technology for high-gain, polarization-sensitive antennas and related signal-processing approaches. Preferred technologies include improving signal to noise ratio (SNR) to improve range, resolving ambiguity of pulses in a combined ranging/spectroscopy function, and permitting the system to visualize multiple target orientations.

Spectroscopic imaging with portable terahertz (THz) or sub-millimeter-wave (SMM) sources and detectors holds great promise for both defense and dual-use applications, such as for detection of chemical/biological weapons (CBW), concealed explosives and other weapons (particularly non-metallic varieties), and even through-the-wall imaging. To perform spectroscopy with active illumination of the target, either multiple or tunable continuous-wave (CW) sources or broadband pulsed sources are important; passive illumination (e.g. using the cold sky) is limited to outdoor settings.

While using incoherent (or intentionally decohered) illumination, either from the sky, a noise source, or a frequency-modulated CW source helps to reduce the interference caused by standing-wave phenomena (analogous to laser speckle), all such approaches have severe limitations in that they cannot perform accurate ranging, they are limited to a narrow range of frequencies, or are relatively weak. They are also all fundamentally limited to incoherent detection, which has limited signal-to-noise ratio (SNR) performance, lacking the advantages of heterodyne downconversion and detection.

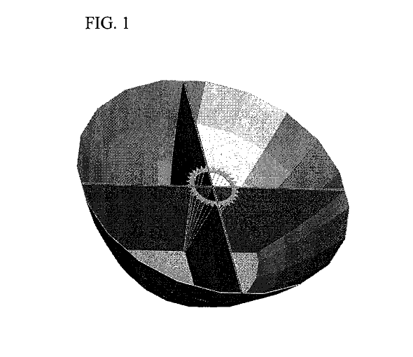

Using pulsed, broadband, coherent THz or SMM sources and detectors is ideal for spectroscopic imaging and detection, but until now these approaches, whether optoelectronic or purely electronic, have been severely limited by standing-wave effects that arise from their coherence: interference between multiple targets that are positioned at integer multiples of λ/2, where λ is the wavelength of interest. Means of modulating the pulse stream would potentially reduce this ambiguity without a corresponding reduction in average power. In an analogous application, optical time-domain reflectometers use Golay or pseudo-random bit stream (PRBS) codes to modulate each transmitted laser pulse. These approaches, however, use modulation techniques that are difficult to implement on the electronic pulse stream of fast-repetition-rate THz spectrometers that otherwise have high average power. As illustrated in FIG. 1, however, embodiments of the present invention implement a pulse modulation scheme using interference among differently-polarized but otherwise identical THz waves using novel antennas. See FIG. 1, Four-quadrant ultrawideband (THz) antenna for polarization-modulated transmit and receive array element.

Embodiments of the present invention offer a unique approach to encoding a stream of pulses from a portable, broadband, and coherent THz or SMM-wave spectrometer. Unlike the traditional pulse modulation schemes, the approach of these embodiments is not only free of their drawbacks but also confers the crucial benefit of sensing polarization. The essence of the approach is to drive two orthogonally-polarized, co-axial ultrawideband antennas with identical pulse streams whose relative phase is modulated by a PRBS or other code. The resultant interferogram is a summation of the polarization vectors from each antenna, giving a polarization-coded pulse stream. An identical pair of antennas (FIG. 1) is used for the receiver, each antenna detecting its own polarization, and the resultant signal correlated with the transmitted code, eliminating ambiguity while simultaneously sensing both components of the polarization vector.

Providing defense against asymmetric threats under different environmental conditions requires both broad spectral sensing and technologies capable of execution in highly mobile platforms. Broadband terahertz (THz) sensors built on all-electronic emitters and detectors can be small, light and low-power enough to be hand-held or mounted on unmanned aerial vehicles (UAVs), while optoelectronic THz systems are useful for laboratory proof-of-principle demonstrations. In both cases, however, ambiguity arising from overlapping pulses, coupled with standing waves resulting from the coherence of these sources and detectors make THz imaging difficult to realize when working distances exceed a few meters. The goal of THz imaging is to enable field-deployable systems to perform spectroscopic imaging at distances of 10 m or more.

In some embodiments, the present invention provides a portable, high-power, real-time, all-electronic broadband terahertz-frequency spectroscopic imaging system with sufficient spatial and spectral resolution to enable the rapid and effective detection of threats using hardware that is compatible with field-deployable, battery-powered embodiments. A preferred system, in some embodiments, should be able to resolve objects down to 1 cm in size, have a ranging capacity of a few meters and possess a spectral bandwidth over the approximate frequency range 0.1 to 1 THz. This system incorporates data analysis algorithms and provides parallel efforts made to collect signature information for a set of expected targets and concealment materials.

The present invention provides new class of imaging spectrometers that can be used to rapidly monitor for chemical/biological agent emission as is needed in many industrial applications. This spectroscopic technique can also be applied for the electromagnetic probing of high-speed processes that occur in materials and devices. This capability has commercial ramifications in areas such as semiconductor materials characterization and medical diagnostics of cells and tissue. This same technology has use in military applications such as point and standoff detection of chemical and biological agents and to contribute to the enhancement of satellite communications and imaging systems.

Increasingly sophisticated weapons and explosives require increasingly sophisticated detection technologies. Non-metallic varieties of these threats are especially important because they can elude conventional detection means such as magnetometers. Threats like these, however, may be readily detectable using broadband near-THz signals, ranging from 0.1 to over 500 GHz.

Several advantages stem from this new approach to target identification. Among these advantages are that the system would obtain early warning at coarser resolutions but greater (e.g. 100 meter) standoff than achievable with visible or infrared (IR) techniques; for example, a UAV could then maneuver closer for confirmation of the target. Rapid, millisecond-level imaging is also contemplated, due to availability of wide intermediate-frequency bandwidths in the MHz regime. These advantages maximize the probability of detection (POD) under varying weather conditions while minimizing the false-alarm rate (FAR).

Extremely short electrical impulses (1-100 ps) have correspondingly broad frequency spectra, which can range from the radio-frequency (RF) through the microwave and millimeter-wave regime. Ultrawideband radiation of this range is difficult to generate and radiate with good fidelity, but has great potential in spectroscopic imaging for target identification; most chemical compounds show strong and specific absorption and dispersion in the 1-1000 GHz range[1]. Gaining spatial resolution with arrays of these sources and detectors and spectral resolution from their broadband characteristics would ultimately enable new and more informative images to be formed.

In some embodiments, the present invention employs an integrated-circuit nonlinear transmission line (NLTL)—which can essentially trade power for speed, producing pico- or even sub-picosecond pulses with peak powers less than one watt and average powers in the low microwatt regime, which are sufficient for driving transient digitizers (samplers) given high-power UWB generators. These power levels are non-ionizing and biologically inconsequential, but because coherent generation using a unique and patented dual-source interferometer can be employed[3-7], rejecting noise outside the frequencies of interest, target identification while using room-temperature detectors optimized for both sensitivity and low cost can be performed. Furthermore, the sensitivity of conventional UWB systems (normally having frequency limits below 10 GHz) to higher frequencies can be extended. For example, experiments conducted during the development of embodiments of the present invention have proven that chemical and material contrast is available in the 10-500 GHz regime to detect the presence of concealed threats.

In contrast to the more common hybrid optoelectronic techniques which use bulky and expensive lasers for generating broadband radiation[8-11], embodiments of the technology is based on entirely electronic integrated circuits, and has already proven itself in a variety of other spectroscopic applications. Broadband (as opposed to single-wavelength) imaging has the chief advantage of flexibility: if weapons change composition over the years, a single-wavelength or narrowband source may no longer detect the new composition, but having a broad range of frequencies maximizes the opportunity to detect the new threat's signature.

For example, Semtex-His commonly used by terrorists and, although examples are of variable composition, it typically contains approximately 8% oil, 9% rubber, and approximately equal quantities of RDX and PETN, but with known composition ranges of >21.5% RDX and <64.5% of PETN. Normally this would require several single-wavelength spectroscopy systems to adequately detect its presence; a broadband system should be able to recognize a variety of signatures arising from the variations in composition. Recently, there has been great interest in the development of more energetic materials, and several new compounds are expected to replace existing materials. Examples include ADN (Ammonium Dinitramide, NH₄N(NO₂)₂, used as a propellant by the Soviet Union), CL-20 (hexanitrohexazaisowurtzitane, a.k.a. HNIW, the most powerful single-component explosive known), and TNAZ (1,3,3-trinitroazetidine).

Furthermore, the advantages of this approach to security over other imaging techniques include smaller size, lower cost, and potential for integration directly with other imaging modalities, all resulting from the integrated-circuit approach. Embodiments of the present invention provide particular use in screening plastic weapons and explosives reliably, quickly, and economically without the invasive detail imaged by other techniques, such as computerized tomography[12].

### Systems and Devices

In some embodiments, the present invention provides a hand-held THz/magnetometer system. In some embodiments, the hand-held THz/magnetometer systems is used in the detection of ceramics, explosives, drugs, etc (e.g., concealed metal items).

In some embodiments, the present invention provides a THz/visual imaging system in which a subset of the pixels in the visual display are false-colored to convey THz spectral information (e.g., reducing complexity, expense, size, weight, etc.) and improving ease of use; and eliminating or reducing privacy concerns. In some embodiments, the power requirements are consistent with it being hand-held or integrated in unmanned vehicles.

In some embodiments, the systems and devices have therein a laser pointer for purposes of painting a dot on a target (e.g., an offending target).

In some embodiments, the systems and devices are configured for wireless communication (e.g., for purposes of a wireless broadcast) (e.g., for purposes of wirelessly broadcasting to a recording device for debriefing, and to additional viewers in other locations).

### Nonlinear Transmission Lines

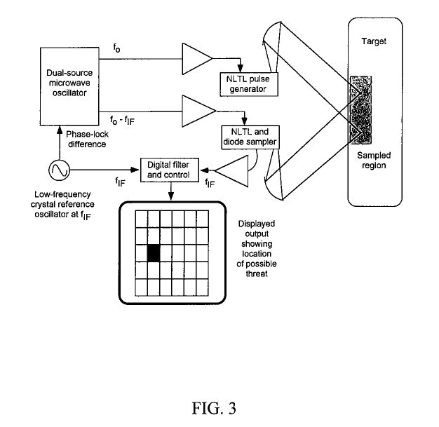

Nonlinear transmission lines (NLTLs) in the work to date are integrated circuits on GaAs consisting of series inductors (or sections of high-impedance transmission line) with varactor diodes periodically placed as shunt elements, as shown in FIG. 3. On typical structures a fast (˜1-10 ps) voltage step develops from a sinusoidal input because the propagation velocity u is modulated by the diode capacitance. Limitations of the NLTL arise from its periodic cutoff frequency, waveguide dispersion, interconnect metallization losses, and diode resistive losses. NLTLs are usually pumped by ˜1 W microwave sinusoidal sources, although more efficient square-wave generators (exciters) may be employed to lower overall power requirements. Two phase-locked synthesizers can be used, one to drive the generator and the other to drive a detector consisting of another NLTL and a diode sampling bridge; this arrangement is analogous to the familiar “pump-probe” techniques used in laser-based spectroscopy.

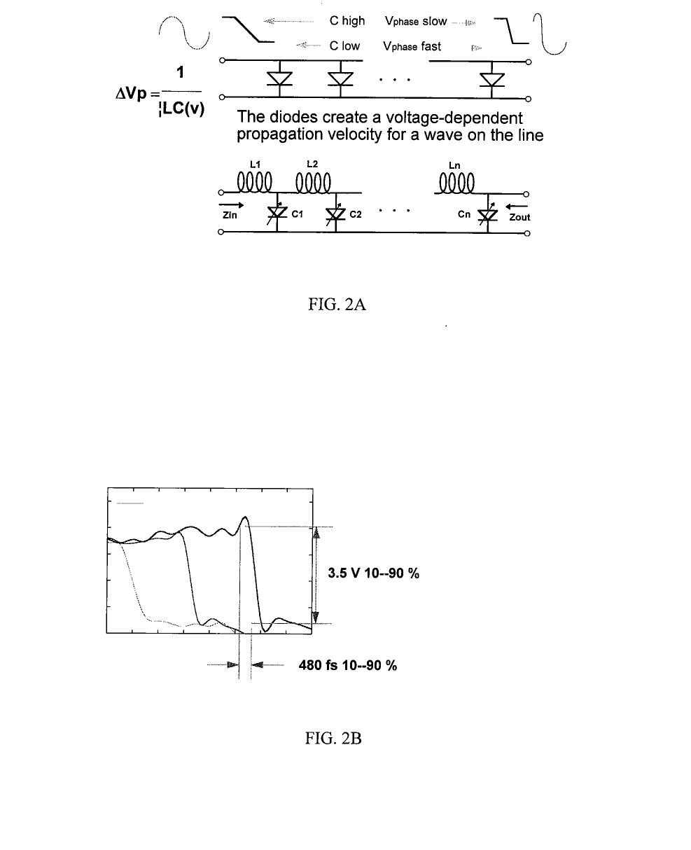

See FIG. 2a, Schematic layout and operation of a nonlinear transmission line. See also FIG. 2b, State-of-the-art NLTL output, measured by integrated sampling bridge (below). The progression of waveforms shows the effects of increasing drive power at the NLTL input[13].

Substantial improvements in GaAs NLTL performance by using a delta-doped profile for the diodes, enabling both highly nonlinear capacitance-voltage characteristics and, with a simple etching step, extremely low-capacitance diodes for ˜7 THz RC cutoff frequencies has previously been reported[13]. These circuits at room temperature have generated and measured 480 fs, 3.5 V step waveforms, the fastest electronic circuits to date.

While these GaAs integrated circuits exhibit highest performance, they are “overkill” for spectroscopic imaging of explosives, especially since water-vapor absorption lines begin to limit free-space spectroscopy above 500 GHz. Thus, in some embodiments, the requirements for highest-frequency performance on some GaAs emitters and detectors in order to get higher efficiency and higher output power were relaxed. Eliminating the microwave synthesizers and using phase-locked crystal oscillators instead can also dramatically lower system costs.

See FIG. 3, Single-pixel concept for the reflection spectroscopic imaging systems.

FIG. 3 describes the overall concept for the all-electronic THz generator and detector to be implemented in a sensor system embodiment of the present invention, based on a coherent measurement system that emits and detects short baseband pulses of electromagnetic energy that propagate out to the target. The THz reflection properties of the target modify the pulses, whose polarization is preserved throughout this process, enabling detection of any orientation dependence of the target, which is of particular importance when seeing to detect concealed firearms, wires for explosives, and other elongated shapes.

In some embodiments, ultra-broadband (pico- and sub-picosecond) pulses from nonlinear transmission line (NLTL) pulse generators are used to provide more information about targets. Specifically, spectral analysis of the returned pulse is contemplated to provide information about both material and geometrical properties of the target. Other attempts at using ultra-broadband sources have been limited by the low average power available from the source. The NLTL pulse generator is limited in the peak power it can produce, but is able to work at very high pulse repetition frequencies (>10 GHz) and therefore can produce reasonable average power approaching 0.5 W per NLTL.

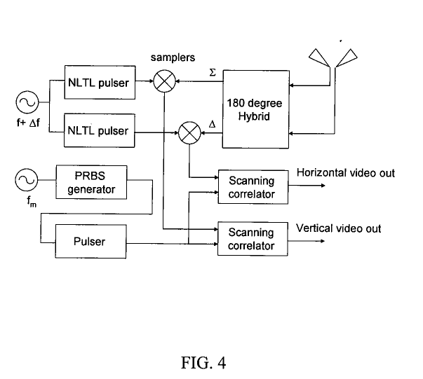

FIG. 4 depicts a coherent receiver architecture for antennas useful in embodiments of the present invention. FIG. 4 shows how nonlinear transmission line (NLTL) pulsers driving samplers using frequencies f and Δf result in down converted pulse replicas having distinct polarizations detected through two channels τ and Δ. A modulation rate fₘ drives a pseudo-random bit stream (PRBS) generator, providing a means of encoding the two channels, and enabling the two scanning correlators to resolve range ambiguity of pulses from the NLTLs. These pulses can be emitted at fundamental frequencies of 10-20 GHz or more, which provides a distinctive advantage in power over conventional optoelectronically generated THz pulses, which are typically 80-100 MHz, set by the mode-locked lasers that drive them. Encoding the pulses with the PRBS is employed in some embodiments of the present invention.

See FIG. 3. Coherent pulsed receiver architecture with polarization sensitivity.

### A Dual-Source Interferometer Using Nonlinear Transmission Lines

To permit high-power arrays and polarization modulation, picosecond-pulse circuits are stimulated based on nonlinear transmission lines (NLTLs) that feed and are fed by UWB antennas. With such electrical pulses (having Fourier components into the 100's of GHz) available from integrated circuits, it is natural to couple them to UWB antennas, as illustrated in See FIG. 4, and radiate these pulses into free space for spectroscopy.

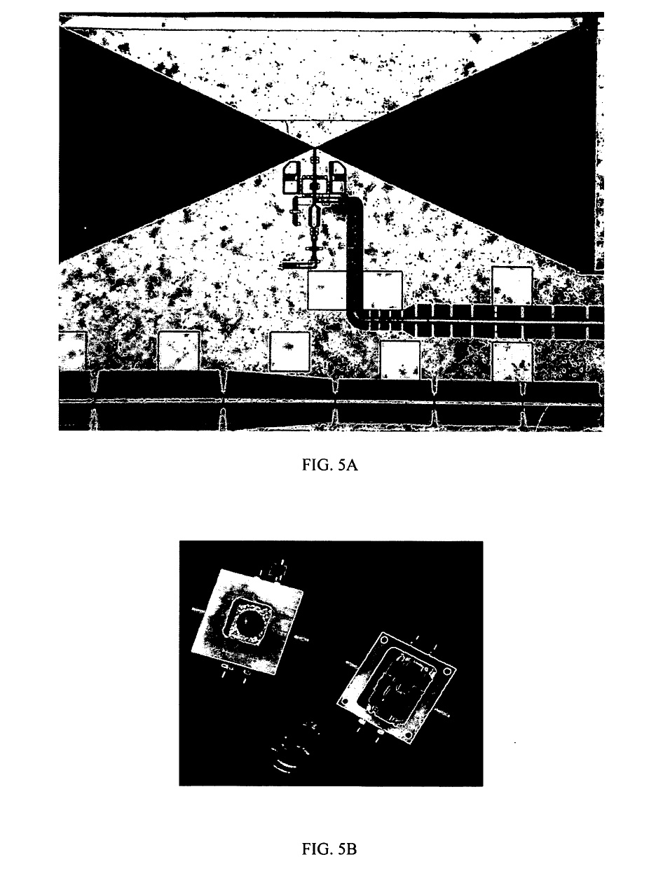

See FIG. 4A, Monolithic NLTL, integrated bow-tie antenna, and diode sampling bridge—note four small bond pads near apex of antenna; FIG. 5B, Packaged generator and detector devices for spectroscopy, with U.S. quarter for scaling.

The ability to perform electronic phase control at the phase-locked sources that drive the NLTLs enables us to provide an interferometer with no moving parts that forms the basis of a polarization-modulation system in some embodiments of the present invention.

In some embodiments, this interferometer uses cross-polarized frequency-independent (planar bow-tie) antennas driven by NLTLs to radiate two beams that are combined with a wire-grid polarizing beamsplitter and then interfere on a second wire-grid polarizer, as shown in FIG. 5.

FIG. 5. Dual-source interferometer configuration. Each source antenna is at the focus of a paraboloidal mirror and radiates a polarized beam, which is transmitted (“A”) or reflected (“B”) by the polarizing beamsplitter (PB). The output polarizer (P) selects half the power of each beam. The output waveform as detected by a bolometer is shown. Each source is fed by a 100-500 mW microwave sinusoid generated by one of two synthesizers, both of which share a common timebase. The output of one synthesizer is offset by Δf<<f_{O} (Δf˜200 Hz; f_{O}˜7 GHz), and this offset is used as a trigger for a spectrum analyzer or a harmonic-selective lock-in amplifier. Each harmonic in Fourier spectrum of source “A” is modulated by a corresponding offset harmonic from source “B” so that the time-domain output can be detected photoconductively, e.g. by a bolometer. In some embodiments, polarized broadband antennas are provided that can accomplish this self-modulation without the use of a beamsplitter.

### Source Coding/Detector Decoding

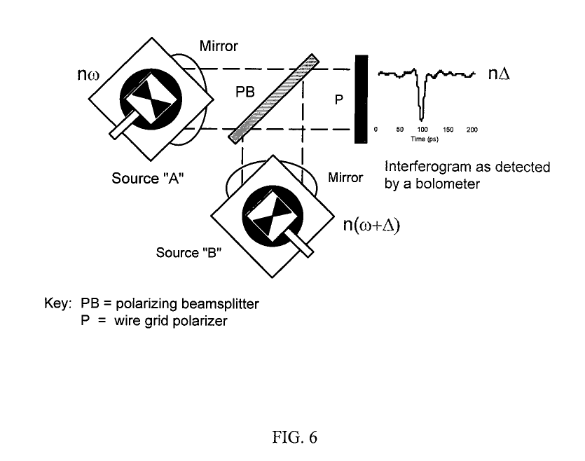

In some embodiments, the dual-source technique that has been demonstrated as a fixed polarization is expanded to enable broadband polarization modulation of both the pulsed UWB source and the detectors. This concept is described in more detail below. In some embodiments, the present invention uses a coherent receiver architecture that with nonlinear transmission line (NLTL) pulsers driving samplers using frequencies f and Δf that result in down converted pulse replicas having distinct polarizations detected through two channels Σ and Δ. As shown in See FIG. 6, a modulation rate fₘ drives a pseudo-random bit stream (PRBS) generator, providing a means of encoding the two channels, and permitting the two scanning correlators to resolve range ambiguity of pulses from the NLTLs. These pulses can be emitted at fundamental frequencies as high as 10-20 GHz or more, which provides a distinctive advantage in power over conventional optoelectronically generated THz pulses, which are typically 80-100 MHz, set by the mode-locked lasers that drive them. These circuits can also be phase locked onto other UWB sources. Fast pulse rates result in range ambiguity that can be too severe to distinguish targets of interest. This further gave rise to standing-wave phenomena that were clearly visible in some of the first THz reflection spectra taken from explosives. Thus, encoding the pulses with the PRBS is a novel and significant development, and further enables processing gain (such as that found in CDMA wireless systems) to offset the noise figure of the diode sampler.

See FIG. 6, Coherent Pulsed Receiver Architecture with Polarization Sensitivity.

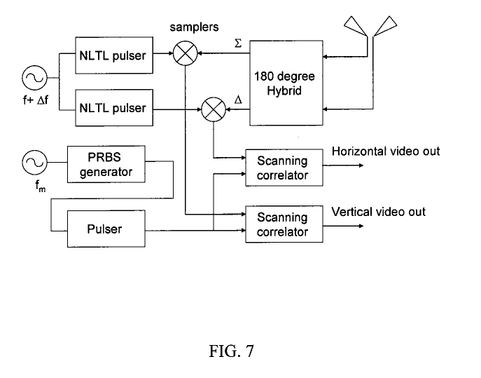

A summary result from simulating this receiver architecture is shown in See FIG. 7. Note that the spectrum of the transmitted pulses is down converted and faithfully replicated at baseband, then unavoidably repeated at higher baseband harmonics, due to the sampling process. Thus, the video signals from both channels can be correctly sampled and recovered.

See FIG. 7. Transmitted (above) and downconverted (below) spectra. The 14 harmonics of the NLTL pulses in the transmitted spectrum are modulated by the PRBS generator, resulting in sidebands indicated.

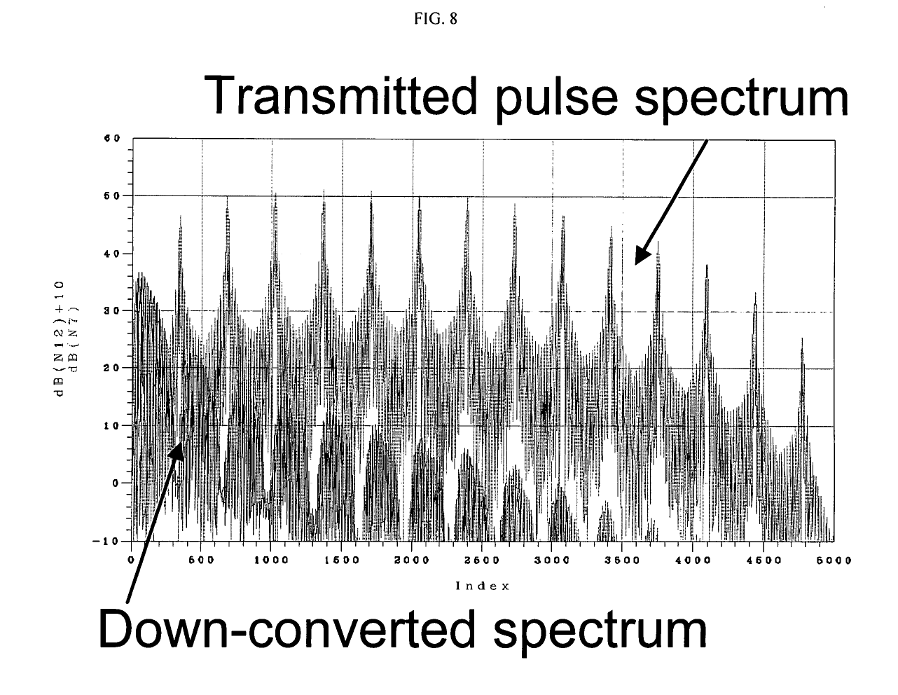

Proof that this technique resolves range ambiguity is shown in See FIG. 8. Undesired pulses are suppressed by the correlators, while the pulse at the target range of interest is enhanced, as shown.

See FIG. 8. Range ambiguity is resolved by PRBS bi-polar coding. Residual unwanted pulse height is reduced by using longer code (3-bits used in this example). Range resolution is determined by pulse width, not modulation rate.

These system-level advances are possible because of the development of the novel ultrawideband class of antenna structures that permit use of pulsed sources while enabling modulation suitable for encoding and decoding.

Realistic simulations of the range that could be expected using parameters of the receiver architecture of See FIG. 6, UWB antennas, and realistic atmospheric conditions were conducted. Even under the most severe attenuation conditions simulated (>100 mm/hour heavy rainfall), a 100-element array, each element radiating 500 mW, would achieve a 15 dB SNR at 100 m standoff.

### Calculated System Parameters

Calculations showed that the system achieves >20 dB SNR from 60 to 400 GHz at 100 meter standoff. Maximum atmospheric absorption would be −4 dB for no rain, <20 dB for heavy rain (>100 mm/hour), realistic for a variety of conditions.

The following references are incorporated herein by reference in their entireties:
[1] B. B. Hu and M. C. Nuss, “Imaging with terahertz waves,” Optics Letters, vol. 20, pp. 1716-18, 1995.
[2] D. Herskovitz, “Wide, Wider, Widest,” Microwave Journal, vol. 38, pp. 26-40, 1995.
[3] D. W. van der Weide, R. H. Blick, F. Keilmann, and R. J. Haug, “Electronic picosecond-pulse interferometer probing the millimeter-wave response of a quantum-dot system,” presented at Quantum Optoelectronics, Dana Point, Calif., 1995.
[4] D. W. van der Weide and F. Keilmann, “Picosecond dual-source interferometer extending Fourer-transform spectrometer to microwave regime,” in 1996 IEEE MTT-S International Microwave Symposium Digest, vol. 3. New York, N.Y., USA: IEEE, 1996, pp. 1731-1734.
[5] P. Akkarackthalin, S. Kee, and D. W. Van Der Weide, “Distributed broadband frequency translator,” presented at Microwave Symposium Digest, 1998 IEEE MTT-S International, 1998.
[6] D. W. van der Weide, J. Murakowski, and F. Keilmann, “Spectroscopy with electronic terahertz techniques,” Proceedings of the SPIE The International Society for Optical Engineering, vol. 3828, pp. 276-84, 1999.
[7] D. W. van der Weide, J. Murakowski, and F. Keilmann, “Gas-absorption spectroscopy with electronic terahertz techniques,” IEEE Transactions on Microwave Theory and Techniques, vol. 48, pp. 740-3, 2000.
[8] M. v. Exeter, “Terahertz time-domain spectroscopy of water vapor,” Optics Letters, vol. 14, pp. 1128-1130, 1989.
[9] M. v. Exeter and D. Grischkowsky, “Optical and electronic properties of doped silicon from 0.1 to 2 THz,” Applied Physics Letters, vol. 56, pp. 1694-1696, 1990.
[10] C. Fattinger and D. Grischkowsky, “Terahertz beams,” Applied Physics Letters, vol. 54, pp. 490-492, 1989.
[11] D. Grischkowsky, S. Keiding, M. v. Exeter, and C. Fattinger, “Far-infrared time-domain spectroscopy with terahertz beams of dielectrics and semiconductors,” Journal of the Optical Society of America B, vol. 7, pp. 2006-2015, 1990.
[12] D. W. van der Weide, “Wideband terahertz sensing and spectroscopy with electronic sources and detectors,” in Terahertz sources and systems, vol. 27, NATO Science Series, R. E. Miles, P. Harrison, and D. Lippens, Eds. Dordrecht, The Netherlands: Kluwer Academic Publishers, 2001, pp. 301-14.
[13] D. W. van der Weide, “Delta-doped Schottky diode nonlinear transmission lines for 480-fs, 3.5-V transients,” Applied Physics Letters, vol. 65, pp. 881-883, 1994.
[14] R. A. Cheville and D. Grischkowsky, “Time domain terahertz impulse ranging studies,” Applied Physics Letters, vol. 67, pp. 1960-1962, 1995.
[15] Allen Taflove and Susan C. Hagness, Computational Electrodynamics: The Finite-Difference Time-Domain Method, 3rd ed., Norwood, Mass.: Artech House, 2005.
[16] S. C. Hagness, A. Taflove, and J. E. Bridges, “Three-dimensional FDTD analysis of a pulsed microwave confocal system for breast cancer detection: Design of an antenna-array element,” IEEE Transactions on Antennas and Propagation, vol. 47, pp. 783-791, May 1999.
[17] X. Li, S. C. Hagness, M. K. Choi, and D. van der Weide, “Numerical and experimental investigation of an ultrawideband ridged pyramidal-horn antenna with curved launching plane for pulse radiation,” IEEE Antennas and Wireless Propagation Letters, vol. 2, pp. 259-262, 2003.
[18] K. Lee, C.-C. Chen, F. L. Teixeira, and R. Lee, “Modeling and investigation of a geometrically complex UWB GPR antenna using FDTD,” IEEE Trans. Antennas and Propagation, vol. 52, pp. 1983-1991, 2004.

1. A portable, high-power, real-time, all-electronic broadband terahertz-frequency spectroscopic imaging system with sufficient spatial and spectral resolution to enable the rapid and effective detection of threats using hardware enabling any orientation dependence of a target, wherein said system is configured to provide information about both material and geometrical properties of said target.

2. A THz/visual imaging system in which a subset of the pixels in the visual display are false-colored to convey THz spectral information.

3. The system of claim 2, further comprising a laser pointer for purposes of painting a dot on a target.

4. The systems of claims 2, configured for wireless communication.
